(19) United States
(12) Patent Application Publication
(10) Pub. No.: US 2003/0002674 A1
(43) Pub. Date: Jan. 2, 2003

(54) Quantum cryptography multi-node network system

(75) Inventors: Yoshihiro Nambu, Tokyo (JP); Akihisa Tomita, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/184,371

(22) Filed: Jun. 28, 2002

(30) Foreign Application Priority Data
Jun. 29, 2001 (JP) 198389/2001

(51) Int. Cl. H04K 1/00

(52) U.S. Cl. 380/256; 257/9; 505/170; 505/202

(57) ABSTRACT

A quantum cryptography multi-node communication system includes a quantum communication channel and a plurality of nodes including a transmission node and a reception node and connected with the quantum communication channel. The transmission node transmits a light signal as a time series of photons to the reception node through the quantum communication channel, a quantum state of the photons is modulated, and transmits a quantum state sequence to the reception node. The reception node predetermines a quantum state sequence, receives the light signal transmitted from the transmission node, measures quantum states of the received light signal, and determines presence or absence of interception based on the predetermined quantum state sequence, the transmitted quantum state sequence and the measured quantum states.

### BACKGROUND OF THE INVENTION

1. Field of the Invention

The present invention relates to a quantum cryptography multi-node network and a method of distributing a key on a multi-node network.

2. Description of the Conventional Techniques

In a conventional cryptography, decryption is possible theoretically by obtaining an answer of a kind of mathematical problem. However, an enormous time is necessary to calculate the answer by a computer at present, and the decryption is difficult actually. In this way, the conventional cryptography is based on computationally secure.

On the other hand, a quantum cryptography is unconditionally secure cryptography which is based on a physical law. Therefore, the quantum crypt cannot be decrypted even if there is a computer with infinite ability. Therefore, unconditional safety of a method of sharing a secret key of a common key cryptogram safely between two nodes is proved based on the law of quantum mechanics. The cryptography method is called a quantum key distribution protocol.

The quantum key distribution protocol is a procedure in which a part of a signal with a quantum level transferred on a quantum communication channel is sampled and the secret key of the common key cryptogram is determined while a measurement result is confirmed on a public communication channel by classical communication.

It is guaranteed based on the uncertainty-principle that a mark of interception of the transmitted signal is always left in the transmitted signal of the quantum level. By comparing the mark with data obtained on a public communication channel through classical communication, it is possible to estimate an upper limit of an amount of information intercepted by a false receiver. Also, it is possible to bring the amount of information intercepted by the false receiver close to zero by the technique of the classical privacy amplification protocol in exchange for shortening of the length of the left key, if the amount of information intercepted by the false receiver does not exceed a certain limit. Thus, the safety is unconditionally proved.

The secret key can be always exchanged if quantum cryptography is used. The secure communication becomes possible unconditionally by combining the quantum cryptography with the one-time-pad method which is a common key cryptogram.

For the quantum key distribution protocols, various protocols are proposed such as 4-state cryptography, 2-particle interference cryptography, non-orthogonal 2-state cryptography, and time difference interference cryptography. These protocols are described in Japanese Laid Open Patent Application (JP-P2000-286841A) in detail.

In these quantum key distribution protocols, generally, a single photon is used as a signal of a quantum level, and an optical fiber communication channel or a spatial light communication channel is used as a quantum communication channel. In this case, it is required to provide a private communication channel between a transmitter node and a receiver node for the key distribution. For this reason, when the distribution of the quantum cryptographic key should be carried out between the four terminals 84, 85, 86, and 87, it is required to provide six private communication channels 81-1, 81-2, 81-3, 81-4, 81-5, and 81-6 between the four terminals, as shown in FIG. 1.

In conjunction with the above description, a key distribution system using a quantum cryptography is disclosed in Japanese Laid Open Patent application (JP-A-Heisei 8-505019). In this reference, a communication method uses a quantum cryptography to encode and decode a signal. A key is distributed on a quantum communication channel, and data is transmitted from a transmitter node to a receiver node on a public communication channel to determine whether or not the key is intercepted on the quantum communication channel. Common communication medium is used for the quantum communication and the public communication. A calibration signal is transmitted on the public communication channel of the common communication medium to calibrate a system for transmitting the key on the quantum communication channel. The communication medium may be an optical fiber. The transmitting units may be switched between the output of a single photon for a quantum communication and the output of multiple photons for the public communication.

Also, quantum cryptography on a multi-node connection network is disclosed in Japanese Laid Open Patent application (JP-A-Heisei 9-502320). In the quantum cryptography in this reference, a transmitter node communicates with some of receiver nodes on the quantum communication channel. The receiver nodes are arranged in different branches of a common communication network. This method establishes a secret key different for each receiver node. To synchronize the receiver node before transmission on the quantum communication channel, a timing pulse is transmitted from the transmitter node to the receiver node. Signals on the quantum communication channel are multiplexed and data is transmitted simultaneously with classical multiplexed photon transmission on the network.

Also, an optical communication apparatus is disclosed in Japanese Laid Open Patent application (JP-A-Heisei 10-290213). In this reference, optical signals multiplexed with different wavelengths light is branched on the way of a transmission route. An optical communication device can absorb the optical signal with the wavelength shorter than a wavelength corresponding to an applied reverse bias potential and demodulate the absorbed signal into an electric signal. Also, the optical communication device can transmit the optical signal with the wavelength longer than the wavelength corresponding to the applied reverse bias potential. The optical communication device is comprised of a pair of front stage and end stage electric field absorption type modulation devices. A reverse bias supply circuit applies the reverse bias potentials to the modulation devices in such a manner that the bias potential on the front stage is lower than that of the end stage.

Also, a quantum cryptography communication system is disclosed in Japanese Laid Open Patent Application (JP-P2000-101570A). In this reference, interception is detected based on the change of a probability distribution in quantum mechanics due to the interception. The distribution is defined by the amplitude and phase of an optical signal. The optical signal from a transmitter node is split into a reference signal strong in intensity and a transmission signal feeble to the extent that the change of a state in the quantum mechanics can be detected. In the transmission, a phase difference is applied between the reference signal and the transmission signal. The difference is determined between the two output lights in the relation of the opposite phase to each other by combining the reference signal and the transmission signal. A secret key is shared between the transmitter node and the receiver node based on a frequency distribution of the difference between the output lights which depend on the fluctuation of a quantum state of the transmission signal. In addition, the fluctuation of the quantum state of the transmission signal is directly detected. At this time, the state of the transmission signal is determined based on reference values which are set to a signal of the difference between the output lights.

Also, a method of distributing a key using a quantum cryptography is disclosed in Japanese Laid Open Patent Application (JP-P2000-286841A). In this reference, a transmitter node modulates a first signal by making 1-bit data correspond to two orthogonal states in quantum mechanics. At this time, the transmitter node selects two orthogonal states from quantum mechanical states randomly every the first signal. The first signal is transmitted to the receiver node on a quantum communication channel to distribute a random number table. After the first signal reaches the receiver node, the transmitter node notifies a method of measuring the first signal to the receiver node through a classical communication channel. The receiver node keeps the received first signal for a predetermined time, and produces a random number table from the 1-bit data obtained through the measurement based on the method of measuring the first signal. The transmitter node and the receiver node extract test data from the transmitted random number tables and the received random number table, respectively, and check the test data by notifying the extracted test data each other through the classical communication channel for confirming that there is not interception. Then, the random number table from which the test data is excluded is used as a common key.

Also, a quantum encrypt apparatus is disclosed in Japanese Laid Open Patent Application (JP-P2000-517499A). In this reference, at least two light pulses are transmitted through a quantum communication channel. An interference generated the light pulse is detected at one of stations. The light pulses which interfere with each other are transferred on a same branch as that of an interferometer. However, the light pulses are delayed in another sequence when they are transferred on the quantum communication channel.

### SUMMARY OF THE INVENTION

Therefore, an object of the present invention is to provide a quantum cryptography multi-node communication network system in which quantum crypts are transmitted and received between multi-nodes.

Another object of the present invention is to provide a quantum cryptography multi-node communication network system, in which a crypt key can be shared between unspecified nodes on a network, while keeping the principle of quantum cryptography.

In an aspect of the present invention, a quantum cryptography multi-node communication system includes a quantum communication channel and a plurality of nodes including a transmitter node and a receiver node and connected with the quantum communication channel. The transmitter node transmits a light signal as a time series of photons to the receiver node through the quantum communication channel, a quantum state of the photons is modulated, and transmits a quantum state sequence to the receiver node. The receiver node predetermines a quantum state sequence, receives the light signal transmitted from the transmitter node, measures quantum states of the received light signal, and determines presence or absence of interception based on the predetermined quantum state sequence, the transmitted quantum state sequence and the measured quantum states.

Here, a single route may be predetermined between the transmitter node and the receiver node. In this case, it is desirable that a reception wavelength of the light signal is assigned to each of the plurality of nodes, and that the receiver node receives the light signal as the time series of photons with the assigned wavelength.

Also, the plurality of nodes may include a plurality of the receiver nodes. At this time, a same wavelength of the light signal may be assigned to the plurality of receiver nodes. In addition, each of the plurality of receiver nodes may receive the light signal with the assigned wavelength, and output the light signal with the assigned wavelength onto the quantum communication channel.

Also, each of the plurality of nodes may connected with the quantum communication channel via a passive optical unit. At this time, the passive optical unit may include a passive wavelength dependent splitter and a passive wavelength dependent combiner. The passive wavelength dependent splitter splits a first light signal component with at least one predetermined first wavelength from the light signal on the quantum communication channel to output to the node. The passive wavelength dependent combiner combines a second light signal component with at least one predetermined second wavelength outputted from the node and the light signal in which the first light signal component is split and outputs the combined light signal onto the quantum communication channel. In this case, it is desirable that the first light signal component is same as the second light signal component. Also, it is desirable that the first wavelength is same as the second wavelength.

Also, when the node outputs the second light signal component with a plurality of the second wavelengths, the passive wavelength dependent combiner may include first and second splitters, a plurality of first combiners and a second combiner. The first splitter splits the light signal, in which the first light signal component is split, into first signal components with different wavelengths. The second splitter splits the second light signal component into second signal components with different wavelengths. Each of the plurality of first combiners combines one of the first signal components and a corresponding one of the second signal components to produce a combined signal component. The second combiner combines the combined signal components to output the light signal onto the quantum communication channel.

Also, the transmitter node may include a transmission quantum state order storage section, a light signal generating section and a transmission section. The transmission quantum state order storage section stores a quantum state sequence. The light signal generating section generates the light signal as the time series of photons having a predetermined wavelength and modulated based on the quantum states stored in the transmission quantum state order storage section. The transmission section transmits the light signal onto the quantum communication channel, and outputs the quantum state sequence to the receiver node.

Also, the receiver node may include a first quantum state storage section which stores the predetermined quantum state sequence. A quantum state measuring section receives the light signal transmitted from the transmitter node through the quantum communication channel, and measures the measured quantum state sequence from the received light signal based on the predetermined quantum state sequence. A second quantum state storage section stores the measured quantum state sequence by the quantum state measuring section. A third quantum state storage section stores the transmitted quantum state sequence from the transmitter node, after the reception of the signal light. A first comparing section compares the predetermined quantum state sequence and the transmitted quantum state sequence to detect coincident quantum states. A fourth quantum state storage section stores ones of the measured quantum states corresponding to the coincident quantum states as a comparison resultant quantum state sequence. A second comparing section compares sampled quantum states which are randomly sampled from the comparison resultant quantum state sequence and ones of the measured quantum state sequence corresponding to the sampled quantum states. A determining section determines the presence or absence of interception based on the comparing result by the second comparing section.

In another aspect of the present invention, a quantum cryptography apparatus to be connected with a quantum communication channel, includes a first quantum state storage section which stores first quantum states of a signal light in a predetermined order. A quantum state measuring section receives the signal light which is transmitted through the quantum communication channel, and measures second quantum states of the signal light from the received signal light based on the first quantum states of the signal light stored in the first quantum state storage section. A second quantum state storage section stores the second quantum states of the signal light which are measured by the quantum state measuring section. A third quantum state storage section stores the first quantum states of the signal light which are transmitted after the reception of the signal light. A first comparing section compares the first quantum states stored in the first quantum state storage section and the first quantum states stored in the third quantum state storage section to detect coincident quantum states. A fourth quantum state storage section stores ones of the measured second quantum states corresponding to the coincident quantum states. A second comparing section compares the second quantum states which are randomly sampled from the second quantum states stored in the fourth quantum state storage section and ones of the measured second quantum states corresponding to the sampled second quantum states. A determining section determines presence or absence of interception based on the comparing result by the second comparing section.

Here, the quantum cryptography apparatus may transmit the signal light as a time series of photons to a receiver node through the quantum communication channel, a quantum state of the photons is modulated, and transmits the quantum states of the signal light to a receiver node. In this case, the quantum cryptography apparatus may further include a transmission quantum state order storage section, a light signal generating section and a transmission section. The transmission quantum state order storage section stores the quantum states of the signal light. The light signal generating section generates the signal light and modulated based on the quantum states stored in the transmission quantum state order storage section. The transmission section transmits the signal light onto the quantum communication channel, and outputs the quantum states of the signal light to the receiver node.

Also, a single route may be predetermined between the transmitter node and the receiver node.

Also, a reception wavelength of the signal light may be assigned to the quantum cryptography apparatus, and the quantum cryptography apparatus may receive the signal light as the time series of photons with the assigned wavelength.

In another aspect of the present invention, a key delivering method in a multi-node network, is achieved: by (a) transmitting a light signal as a time series of photons from a transmitter node to a receiver node through a quantum communication channel, a quantum state of the photons is modulated; by (b) transmitting a quantum state sequence from the transmitter node to the receiver node; by (c) receiving the light signal transmitted from the transmitter node, and measuring a quantum state sequence of the received light signal; and by (d) determining presence or absence of interception based on a quantum state sequence predetermined on the receiver node, the transmitted quantum state sequence and the measured quantum state sequence.

Here, a single route may be predetermined between the transmitter node and the receiver node. In this case, a reception wavelength of the light signal may be assigned to each of the plurality of nodes. The (c) receiving step is achieved by receiving the light signal as the time series of photons with the assigned wavelength.

Also, a plurality of nodes may be connected with the quantum communication channel and includes a plurality of the receiver nodes, and a same wavelength of the light signal may be assigned to the plurality of receiver nodes. The (c) receiving step is achieved by each of the plurality of receiver nodes receiving the light signal with the assigned wavelength, and outputting the light signal with the assigned wavelength onto the quantum communication channel.

Also, the (a) transmitting step may be achieved by generating the light signal as the time series of photons having a predetermined wavelength; by modulating the light signal based on a first quantum state sequence; and by transmitting the light signal from the transmitter node to the receiver node through the quantum communication channel.

Also, the (c) receiving step may be achieved by receiving the light signal transmitted from the transmitter node through the quantum communication channel; by measuring the measured quantum state sequence from the received light signal based on a quantum state sequence predetermined on the receiver node; by comparing the predetermined quantum state sequence and the quantum state sequence transmitted from the transmitter node to detect coincident quantum states to produce a comparison resultant quantum state sequence indicating coincidence as a comparing result; and by comparing sampled quantum states which are randomly sampled from the comparison resultant quantum state sequence and ones of the measured quantum state sequence corresponding to the sampled quantum states.

### BRIEF DESCRIPTION OF THE DRAWINGS

FIG. 1 is a conceptual diagram of a conventional quantum cryptography network in which a quantum cryptographic key is delivered on a communication channel;

FIG. 2 is a diagram showing the structure and operation of a quantum cryptography multi-node network system according to the present invention;

FIG. 3 is showing the structures of a transmitter node and receiver node in the quantum cryptography multi-node network system of the present invention;

FIG. 4 is a diagram showing the structure of the quantum cryptography multi-node network system according to a first embodiment of the present invention;

FIG. 5 is a diagram showing the structure of the quantum cryptography multi-node network system according to a second embodiment of the present invention;

FIG. 6 is a diagram showing the structure of the quantum cryptography multi-node network system according to a third embodiment of the present invention;

FIG. 7 is a block diagram showing a 2-input and 1-output light combiner in the quantum cryptography multi-node network system of the present invention;

FIG. 8 is a block diagram showing the structure of a quantum cryptography encoder in the quantum cryptography multi-node network system of the present invention; and

FIG. 9 is a block diagram showing the structure of a quantum cryptography decoder in the quantum cryptography multi-node network system of the present invention.

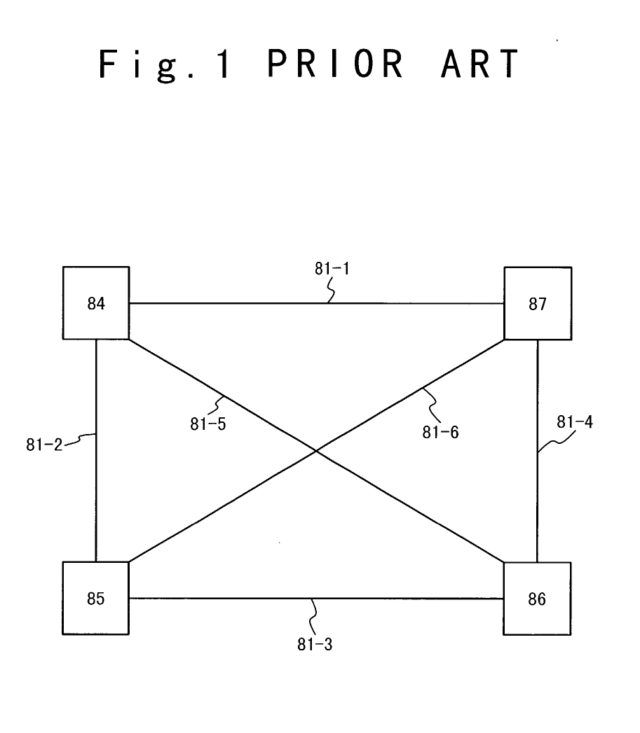

### DESCRIPTION OF THE PREFERRED EMBODIMENTS

Hereinafter, a quantum cryptography multi-node network system of the present invention will be described in detail with reference to the attached drawings.

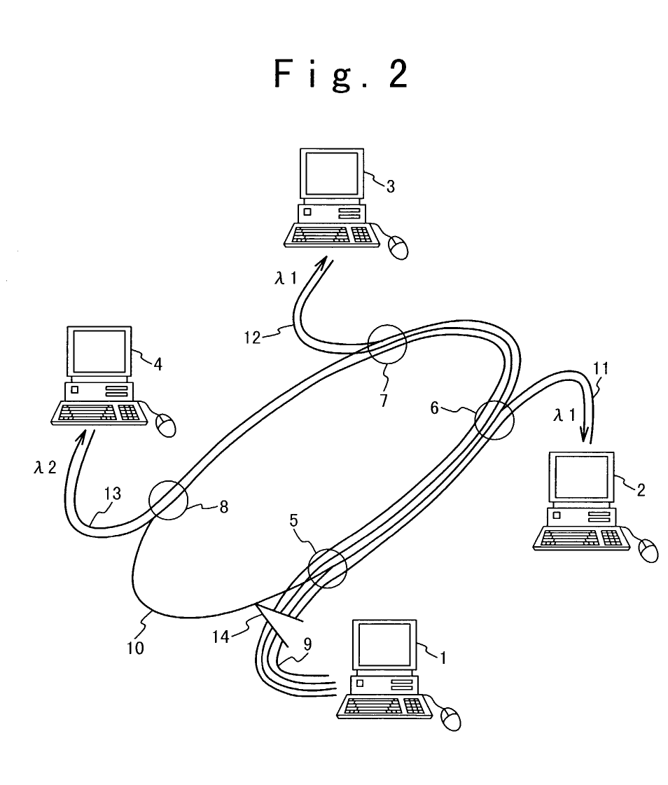

FIG. 2 is a conceptual diagram showing the quantum cryptography multi-node network system of the present invention, and a quantum key is delivered between predetermined two of nodes. Referring to FIG. 2, in the multi-node network, a transmitter node 1 as one of the nodes encodes a single photon or a time series of photons based on key data necessary for protocols such as 4-state cryptography, 2-particle interference cryptography, non-orthogonal 2-state cryptography, and time difference interference cryptography, and delivers to one selected from among receiver nodes 2, 3 and 4.

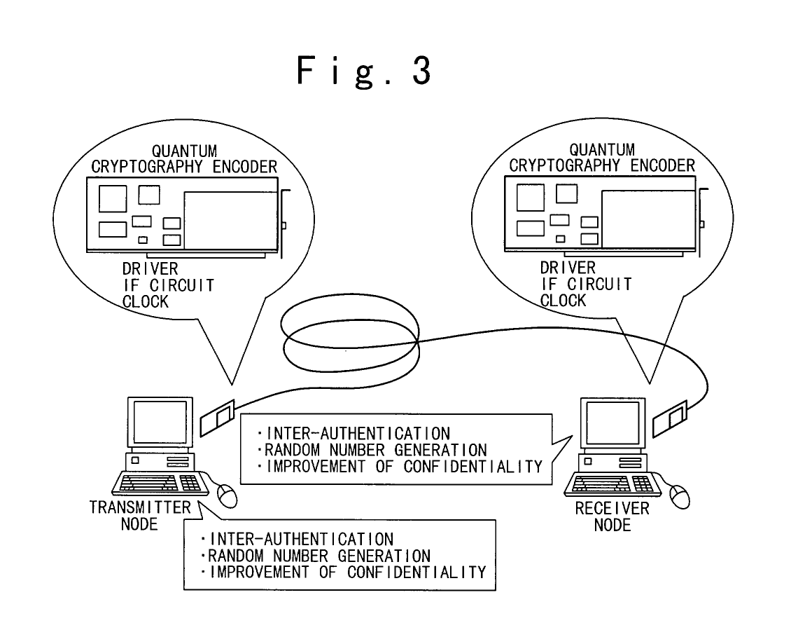

A quantum cryptography encoder and a quantum cryptography decoder which are provided on boards as shown in FIG. 3, and are installed in a node of the transmitter node 1 and nodes of the receiver nodes 2, 3 and 4, respectively. It is possible to carry out a quantum key distribution protocol between the transmitter node and the receiver node using this system. That is, it is possible to carry out the quantum key distribution protocol in usual peer-to-peer communication between the transmitter node and the receiver node using this system.

The transmitter node 1 encodes the quantum key, and outputs a time series of wavelength controlled single photons to an asymmetrical waveguide interference system 5 through a branch line optical fiber 9. The asymmetrical waveguide interference system 5 is a 2-input and 1-output asymmetrical Mach-Zehnder interference system formed using the optical fiber, and operates as a signal wavelength multiplexing unit. The single photon time series 14 reaches an asymmetrical waveguide interference system 6, 7 or 8 through a trunk line optical fiber 10. The asymmetrical waveguide interference system 6, 7 or 8 is same as the asymmetrical waveguide interference system 5, and operates as a 1-input and 2-output signal wavelength splitter. One of the two outputs is connected with the trunk line optical fiber 10 and the other output is connected with a branch line optical fibers 11, 12 or 13. The asymmetrical waveguide interference system 6 is designed to split only the photons with the wavelength of λ1 into the branch line optical fiber 11. The asymmetrical waveguide interference system 7 is designed to split only the photons with the wavelength of λ2 into the branch line optical fiber 12. The asymmetrical light waveguide interference system 8 is designed to split only the photons with the wavelength of λ3 into the branch line optical fiber 13. Therefore, the transmitter node 1 can freely select one of the receiver nodes 2, 3 and 4 by controlling the wavelength of the single photon to be transmitted, and communicates with the selected receiver node in accordance with the conventional quantum key distribution protocol. Thus, a secret key of a common key cryptogram can be shared between the transmitter node and the selected receiver node on the multi-node network.

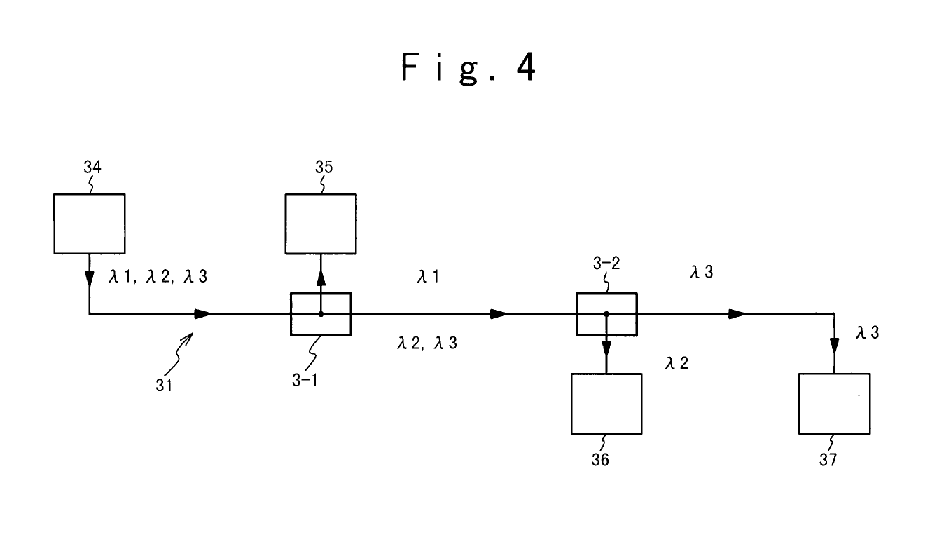

Next, the quantum cryptography multi-node network system according to the first embodiment of the present invention will be described with reference to FIG. 4. Referring to FIG. 4, in the quantum cryptography multi-node network system, a node 34, a node 35, a node 36, and a node 37 are arranged in this order on a main communication channel 31.

The multi-node network system is comprised of a 1-input and 2-output passive optical combiner (AWG) which is connected with the main communication channel 31 to transmit an optical signal with the wavelengths of λ1, λ2 and λ3 from the node 34 to the nodes 35, 36 and 37 on the main communication channel 31. A 1-input and 2-output optical splitter 3-1 passive splits an optical signal with the wavelength of λ1 from the optical signal on the main communication channel 31 to output to the node 35 and outputs the optical signal with the wavelengths of λ2 and λ3 to the main communication channel 31. The 1-input and 2-output optical passive splitter 3-2 splits an optical signal with the wavelength of λ2 from the optical signal with the wavelengths of λ2 and λ3 on the main communication channel 31 to output to the node 35 and outputs the optical signal with the wavelength of λ3 to the main communication channel 31.

A method of delivering a quantum cryptographic key will be described, using a case of transmission of a quantum cryptographic key from the node 34 to the node 36 in the multi-node network system of FIG. 4 as an example.

The node 34 applies quantum states to photons with the wavelength of λ2 in order of the quantum states distributed through a classical communication and outputs the photons to the main communication channel 31 as an optical signal. In case of 4 quantum states, the quantum states are, for example, base state 1 of each polarization state of 0 degrees and 90 degrees, and base state 2 of each polarization state of 45 degrees and 135 degrees. With the outputted photons with the wavelength of λ2, the optical passive splitter 3-1 outputs only the photons with the wavelength of λ2 to the main communication channel 31, and the optical passive splitter 3-2 outputs the photon with the wavelength of λ2 the node 36.

In this case, only one communication route from the node 34 to the node 36 can be selected for the photons with the wavelength of λ2. Therefore, even if photons are intercepted by an interception node on the way of the communication route, an interception node returns the photons with the quantum state different from the initial state in the probability of 1/2 to the communication channel 31, because the interception node does not know the quantum state of the photon. Thus, the true receiver node can know the interception.

In the above description, the method of distributing the quantum cryptographic key from the node 4 to the node 6 is described. However, the quantum cryptographic key can be distributed from the node 4 to an optional one of the nodes 5, 6 and 7.

Moreover, the node 34 can deliver the quantum cryptographic key to the nodes 35, 36 and 37 at a same time, by applying the same quantum state to the photons with the wavelengths of λ1, λ2 and λ3 in order of the quantum states of the photons distributed through the classical communication and by delivering the photons to the main communication channel 31. In this case, only one communication route can be selected to each of the photons with the wavelengths of λ1, λ2 and λ3. Therefore, if any interception is carried out on the way of the communication route, the interception node returns the photon to the communication channel 31 in the quantum state of the photon different from the initial state in the probability of 1/2, because the interception node does not know the quantum state of the photon. Therefore, the true receiver node can know whether the interception is carried out.

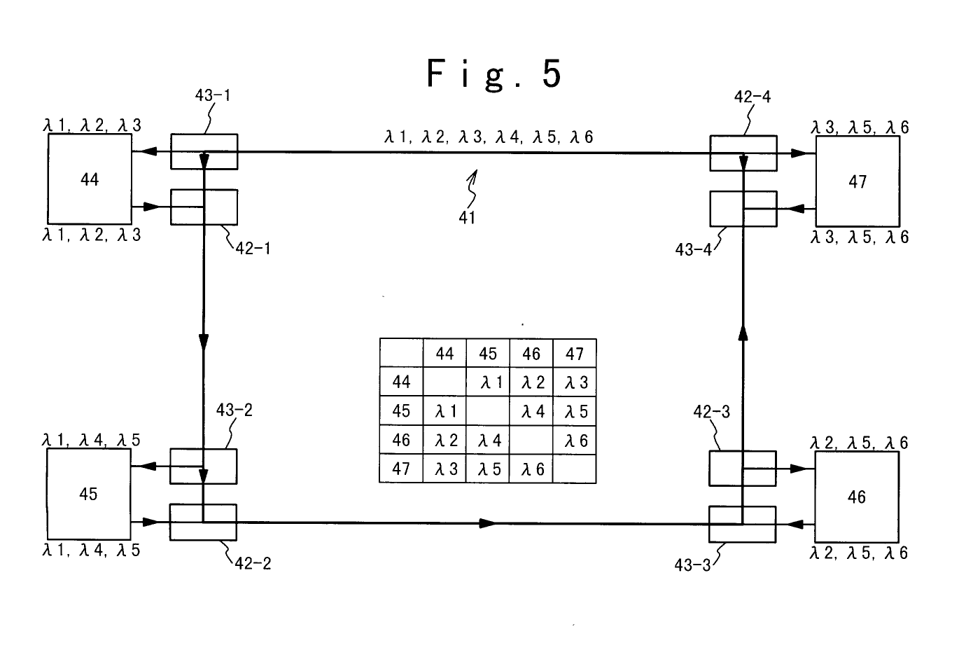

Next, an example of the multi-node network system according to the second embodiment of the present invention will be described with reference to FIG. 5.

In the multi-node network system of FIG. 5, nodes 44, 45, 46, and 47 are connected with a main communication channel 41 annularly arranged. Each of the nodes 44, 45, 46, and 47 is connected with the main communication channel 41 through a 1-input and 2-output optical passive splitter and a 2-input and 1-output optical passive combiner. The main communication channel 41 can transfer an optical signal with the wavelengths of λ1, λ2, λ3, λ4, λ5, and λ6. The wavelength of the optical signal used when the quantum cryptographic key is distributed from one node to another node is shown in the table of FIG. 5.

The node 44 is connected with the main communication channel 41 through a 1-input and 2-output optical passive splitter 43-1 and a 2-input and 1-output optical passive combiner 42-1. The optical passive splitter 43-1 inputs the optical signal on the main communication channel 41, and output an optical signal with the wavelengths of λ1, λ2 and λ3 to the node 44 and the optical signal with the wavelengths of λ4, λ5 and λ6 to the main communication channel 41. The optical passive combiner 42-1 combines the optical signal of the wavelengths of λ4, λ5 and λ6 transferred on the main communication channel, and an optical signal of the wavelength of λ1, λ2, and λ3 outputted from the node 44 and outputs the combined optical signal to the main communication channel 41.

The node 45 is connected with the main communication channel 41 through a 1-input and 2-output optical passive splitter 43-2 or a 2-input and 1-output optical passive combiner 42-2. The optical passive splitter 43-2 inputs the signal on the main communication channel 41, and output the light with the wavelengths of λ1, λ4 and λ5 to the node 45 and light with the wavelengths of λ2, λ3 and λ6 to the main communication channel 41. The optical passive combiner 42-2 combines the light of the wavelengths of λ2, λ3 and λ6 transferred on the main communication channel and the light of the wavelength of λ1, λ4 and λ5 outputted from the node 45 and outputs the combined light to the main communication channel 41.

The node 46 is connected with the main communication channel 41 through a 1-input and 2-output optical passive splitter 43-3 or a 2-input and 1-output optical passive combiner 42-3. The optical passive splitter 43-3 inputs the optical signal on the main communication channel 41, and output the light with the wavelengths of λ2, λ5 and λ6 to the node 46 and light with the wavelengths of λ1, λ3 and λ4 to the main communication channel 41. The optical passive combiner 42-3 combines the light of the wavelengths of λ1, λ3 and λ4 transferred on the main communication channel and the light of the wavelength of λ2, λ5 and λ6 outputted from the node 45 and outputs the combined light to the main communication channel 41.

The node 47 is connected with the main communication channel 41 through a 1-input and 2-output optical passive splitter 43-4 or a 2-input and 1-output optical passive combiner 42-4. The optical passive splitter 43-4 inputs the signal on the main communication channel 41, and output the light with the wavelengths of λ3, λ5 and λ6 to the node 47, and light with the wavelengths of λ1, λ2 and λ4 to the main communication channel 41. The optical passive combiner 42-4 combines the light of the wavelengths of λ1, λ2 and λ4 transferred on the main communication channel and the light of the wavelength of λ3, λ5 and λ6 outputted from the node 47 and outputs the combined light to the main communication channel 41.

In this way, each of the nodes 44, 45, 46 and 47 can deliver a quantum cryptographic key to one or more nodes using the single wavelength or different wavelengths.

A method of delivering a quantum cryptographic key will be described using a case of transmission of a quantum cryptographic key from the node 44 to the node 46 in the multi-node network system of FIG. 5 as an example.

The node 44 gives one of quantum states to a photon with the wavelength of λ2 in order of the quantum states distributed through a classic communication and outputs the photon to one input node of the 2-input and 1-output optical passive combiner 42-1. In case of 4 quantum states, the quantum states are, for example, the base state 1 for each of the polarization states of 0 degrees and 90 degrees, and the base state 2 for each of the polarization states of 45 degrees and 135 degrees. At this time, light with the wavelength of λ2 is not transferred on the main communication channel 41. The 2-input and 1-output optical passive combiner 42-1 outputs the photons with the wavelength of λ2 to the main communication channel 41. The photons with the wavelength of λ2 transferred on the main communication channel 41 are outputted to the main communication channel 41 by the 1-input and 2-output optical passive splitter 43-2, and then only the photons with the wavelength of λ2 are outputted to the main communication channel 41 by the 2-input and 1-output optical passive combiner 42-2. The photons with the wavelength of λ2 are outputted to only the node 46 by the 1-input and 2-output optical passive splitter 43-3.

In the multi-node network system of FIG. 5, only one route can be selected from the node 44 to the node 46 to the photons with the wavelength λ2. Therefore, even if the photons are received by an interception node, the interception node returns the photons to the communication channel 41 in the quantum state of the photons different from the initial states in the probability of 1/2, because the interception node does not know the quantum states of the photons. Therefore, the true receiver node can know the interception by the interception node. In this multi-node network system, the optical passive combiner can be easily formed. However, when the number of nodes increases to n, wavelengths for nC2 must be prepared.

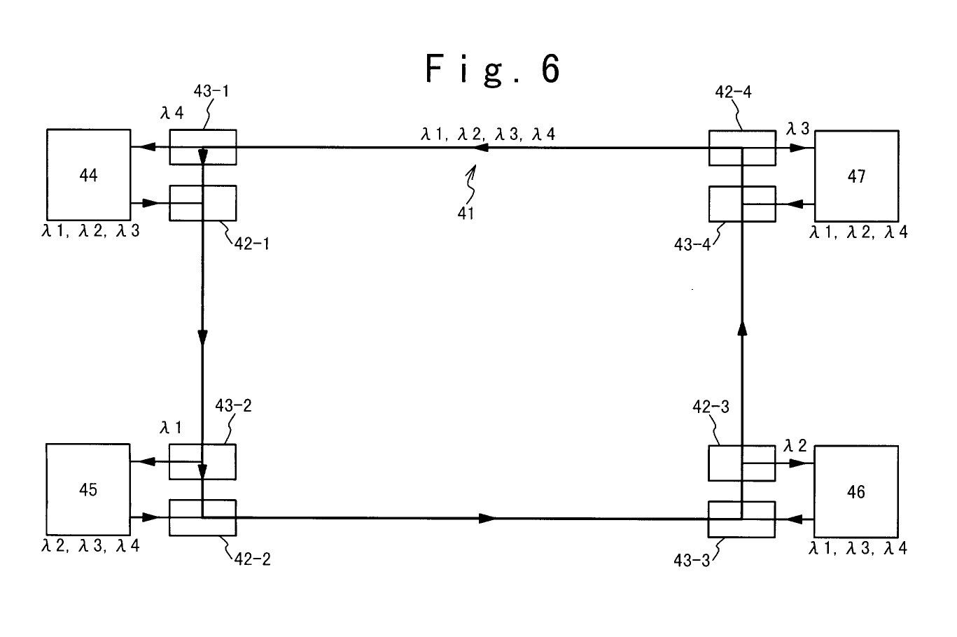

In the multi-node network system of FIG. 6, the nodes 44, 45, 46, and 47 are connected with the main communication channel 41 annularly arranged. Each the nodes 44, 45, 46 and 47 is connected with the main communication channel 41 through a 1-input and 2-output optical passive splitter and a 2-input and 1-output optical passive combiner. The main communication channel 41 can transfer light with the wavelengths of λ1, λ2, λ3, and λ4.

The node 44 is connected with the main communication channel 41 through a 1-input and 2-output optical passive splitter 43-1 and a 2-input and 1-output optical passive combiner 42-1. The optical passive splitter 43-1 inputs an optical signal on the main communication channel 41, and output the light with the wavelength of λ4 to the node 44 and light with the wavelengths of λ1, λ2 and λ3 to the main communication channel 41. The optical passive combiner 42-1 combines the light of the wavelengths of λ1, λ2 and λ3 transferred on the main communication channel, and the light of the wavelengths of λ1, λ2, and λ3 outputted from the node 44 and outputs the combined light as an optical signal to the main communication channel 41.

The node 45 is connected with the main communication channel 41 through a 1-input and 2-output optical passive splitter 43-2 and a 2-input and 1-output optical passive combiner 42-2. The optical passive splitter 43-2 inputs the optical signal on the main communication channel 41, and output the light with the wavelength of λ1 to the node 44 and light with the wavelengths of λ2, λ3 and λ4 to the main communication channel 41. The optical passive combiner 42-2 combines the light of the wavelengths of λ2, λ3 and λ4 transferred on the main communication channel, and the light of the wavelengths of λ2, λ3, and λ4 outputted from the node 45 and outputs the combined light as an optical signal to the main communication channel 41.

The node 46 is connected with the main communication channel 41 through a 1-input and 2-output optical passive splitter 43-3 and a 2-input and 1-output optical passive combiner 42-3. The optical passive splitter 43-3 inputs the optical signal on the main communication channel 41, and output the light with the wavelength of λ2 to the node 44 and light with the wavelengths of λ1, λ3 and λ4 to the main communication channel 41. The optical passive combiner 42-3 combines the light of the wavelengths of λ1, λ3 and λ4 transferred on the main communication channel, and the light of the wavelengths of λ1, λ3, and λ4 outputted from the node 46 and outputs the combined light as an optical signal to the main communication channel 41.

The node 47 is connected with the main communication channel 41 through a 1-input and 2-output optical passive splitter 43-4 or a 2-input and 1-output optical passive combiner 42-4. The optical passive splitter 43-4 inputs the optical signal on the main communication channel 41, and output the light with the wavelength of λ3 to the node 44 and light with the wavelengths of λ1, λ2 and λ4 to the main communication channel 41. The optical passive combiner 42-4 combines the light of the wavelengths of λ1, λ2 and λ4 transferred on the main communication channel, and the light of the wavelengths of λ1, λ2, and λ4 outputted from the node 47 and outputs the combined light to the main communication channel 41.

A method of delivering a quantum cryptographic key will be described using a case of transmission of a quantum cryptographic key from the node 44 to the node 46 in the multi-node network system of FIG. 6 as an example.

The node 44 gives one of quantum states to photons with the wavelength of λ2 in order of the quantum states distributed through a classic communication and outputs the photons to one input node of the 2-input and 1-output optical passive combiner 42-1. In case of 4 quantum states, the quantum states are, for example, the base state 1 for each of the polarization states of 0 degrees and 90 degrees, and the base state 2 for each of the polarization states of 45 degrees and 135 degrees. At this time, the light with the wavelength of λ2 is not transferred on the main communication channel 41. The 2-input and 1-output optical passive combiner 42-1 outputs the photons with the wavelength of λ2 to the main communication channel 41. The photons with the wavelength of λ2 transferred on the main communication channel 41 is outputted to the main communication channel 41 by the 1-input and 2-output optical passive splitter 43-2, and only the photons with the wavelength of λ2 are outputted to the main communication channel 41 by the 2-input and 1-output optical passive combiner 42-2. The photons with the wavelength of λ2 are outputted to only the node 46 by the 1-input and 2-output optical passive splitter 43-3.

In the multi-node network system of FIG. 6, only one route can be selected from the node 44 to the node 46 to the photons with the wavelength of λ2. Therefore, even if the photon is received by an interception node, the interception node returns the photon to the communication channel 41 in the quantum state of the photon different from the initial state in the probability of 1/2, because the interception node does not know the quantum state of the photon. Therefore, the true receiver node can know the interception by the interception node.

In the multi-node network system of FIG. 6, it is possible to select two of the nodes 44, 45, 46, and 47 optionally and transmit a quantum cryptographic key between the selected two nodes. Moreover, it is possible to transmit a quantum cryptogram between a plurality of sets of the two nodes at the same time if photons with different wavelengths are used.

Next, the transmission of the quantum cryptogram between the node 44 and the node 46, and the node 45 and the node 47 will be described.

The node 44 gives one of quantum states to the photons with the wavelength of λ2 in order of the quantum states distributed through a classic communication and outputs the photon to one input node of the 2-input and 1-output optical passive combiner 42-1. In case of 4 quantum states, the quantum states are, for example, the base state 1 for each of the polarization states of 0 degrees and 90 degrees, and the base state 2 for each of the polarization states of 45 degrees and 135 degrees. At this time, the light with the wavelength of λ2 is not transferred on the main communication channel 41. The 2-input and 1-output optical passive combiner 42-1 outputs the photons with the wavelength of λ2 to the main communication channel 41. The photons with the wavelength of λ2 transferred on the main communication channel 41 are outputted to the main communication channel 41 by the 1-input and 2-output optical passive splitter 43-2, and only the photons with the wavelength of λ2 are outputted to the main communication channel 41 by the 2-input and 1-output optical passive combiner 42-2. The photon with this the wavelength of λ2 is outputted to only the node 46 by the 1-input and 2-output optical passive splitter 43-3.

The node 45 gives one of quantum states to the photons with the wavelength of λ3 in order of the quantum states distributed through a classic communication and outputs the photons to one input node of the 2-input and 1-output optical passive combiner 42-2. In case of 4 quantum states, the quantum states are, for example, the base state 1 for each of the polarization states of 0 degrees and 90 degrees, and the base state 2 for each of the polarization states of 45 degrees and 135 degrees. At this time, any light with the wavelength of λ3 is not transferred on the main communication channel 41. The 2-input and 1-output optical passive combiner 42-2 outputs the photons with the wavelength of λ3 to the main communication channel 41. The photons with the wavelength of λ3 transferred on the main communication channel 41 are outputted to the main communication channel 41 by the 1-input and 2-output optical passive splitter 43-3, and only the photons with the wavelength of λ3 are outputted to the main communication channel 41 by the 2-input and 1-output optical passive combiner 42-3. The photons with the wavelength of λ3 is outputted to only the node 46 by the 1-input and 2-output optical passive splitter 43-3.

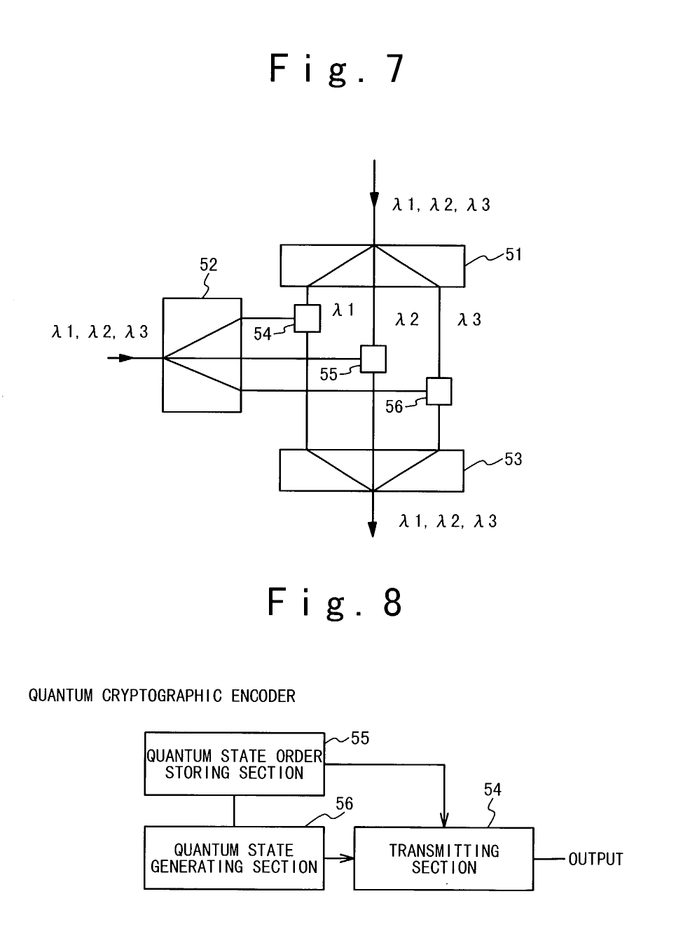

The 2-input and 1-output optical passive combiner 42-1 will be described in details with reference to FIG. 7. The optical passive combiners 42-2, 42-3, and 42-4 have the same structure as the optical passive combiner 42-1. The optical passive combiner 42-1 can be designed based on the similar idea when the nodes are more increased.

The main communication channel 41 can transfer the light with the wavelengths of λ1, λ2, λ3, and λ4. However, the 1-input and 2-output optical passive splitter 43-1 splits the light with the wavelength of λ3 from the light on the main communication channel 41 and outputs the light with the wavelength of λ3 to the node 44. Therefore, only the light with the wavelengths of λ1, λ2, and λ3 are transferred on the main communication channel 41. The combined light with the wavelengths of λ1, λ2 and λ3 is inputted to the 1-input 3-output optical passive splitter 51 and is split into lights with the wavelengths λ1, λ2 and λ3. The light with the wavelength of λ1, λ2 or λ3 outputted from the node 44 is inputted to the 1-input and 3-output optical passive splitter 52 which splits the light with the wavelength of λ1, λ2 and λ3 into the lights with the wavelengths of λ1, λ2 and λ3.

The light with the wavelengths of λ1, λ2 and λ3 on the main communication channel is split into lights with the wavelengths of λ1, λ2 and λ3 by the 1-input and 3-output optical passive splitter 51. Also, the light with the wavelengths of λ1, λ2 and λ3 outputted from the node is split into lights with the wavelengths of λ1, λ2 and λ3 by the 1-input and 3-output optical passive splitter 52. The light with wavelength of λ1 from the passive splitter 51 and the light with the wavelength of λ1 are combined by a passive combiner 54. The light with wavelength of λ2 from the passive splitter 51 and the light with the wavelength of λ2 are combined by a passive combiner 55. The light with wavelength of λ3 from the passive splitter 51 and the light with the wavelength of λ3 are combined by a passive combiner 56. The combined lights with the wavelengths of λ1, λ2 and λ3 are supplied to the 3-input and 1-output optical passive combiner 53. The passive combiner 53 combines the lights with the wavelengths of λ1, λ2 and λ3 from the passive combiners 54, 55 and 56 to produce light with the wavelengths of λ1, λ2 and λ3 and outputs to the main communication channel.

In the multi-node network system of FIG. 6, it is sufficient to prepare the wavelengths for the number of nodes although the structure of the 2-input and 1-output optical passive combiner becomes complicated.

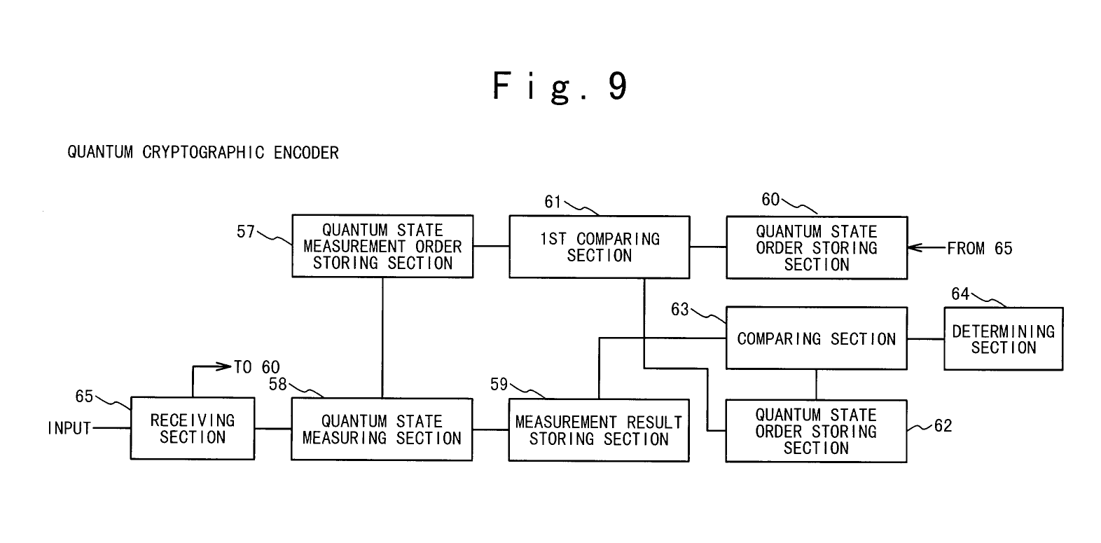

The structure and operation of the quantum cryptography decoder and encoder which are formed on boards with be described with reference to FIG. 8 and FIG. 9, using a case of 4 quantum of the base state 1 for each of the polarization states of 0 degrees and 90 degrees, and the base state 2 for each of the polarization states of 45 degrees and 135 degrees as the example.

FIG. 8 is a block diagram showing the structure of the quantum cryptography encoder. Referring to FIG. 8, in the quantum cryptography encoder, a quantum state order storing section 55 stores an order of the quantum states of the quantum cryptographic key. A quantum state generating section 56 generates photons and gives a determined quantum state (polarization state) to each of the photons based on the quantum states stored in the quantum state order storing section 55. The transmitting section 54 transmits the time series of photons as a light signal onto the quantum communication channel. Also, the transmitting section 54 transmits the quantum states stored in the quantum state order storing section 55 to the receiver node. The quantum states are confirmed through a classic communication.

FIG. 9 is a block diagram showing the structure of the quantum cryptography decoder.

The quantum cryptography decoder is comprised of a quantum measurement order storing section 57, a quantum state measuring section 58 and a measurement result storing section 59. The quantum measurement order storing section 57 stores an order of the quantum states (base states 1 or 2) set by a receiver node. The quantum state measuring section 58 receives the light signal on the quantum communication channel through a receiving section 65 and measures the quantum state (polarization state) of an inputted photon by switching a detecting section (not shown) for detecting the polarization state of the photon based on the base state. The detecting section is a measuring section for measuring 0-degree polarization or 90-degree polarization in case of the base state 1. The measurement result storing section 59 stores the measured polarization state.

After the distribution of the quantum cryptographic key from the transmitter node to the receiver node is completed, the order of the quantum states (the base states) of the quantum cryptographic key is delivered from the transmitter node to the receiver node. The receiver node receives the delivered quantum states (the base states) of the quantum cryptographic key and stores the order in a quantum state order storing section 60. A comparing section 61 compares the order of the base states previously determined in case of the reception, i.e., the order stored in the quantum measurement order storing section 57, and the quantum states (the base states) delivered from the transmitter node. The comparing section 61 stored the quantum states which are coincident with each other in the quantum state order storing section 62 and discards the quantum states which are not coincident with each other.

Next, a comparing section 63 compares the polarization states stored in the quantum state order storing section 62 and the polarization states stored in a measurement result storing section 59. A determining section 64 determines the presence or absence of interception based on the comparing result.

Generally, when the discrepancy is equal to or less than 15%, the interception supposes to be not carried out. It should be noted that there is a determination method in which only a first half is used when the first half is coincident with each other but the second half is not coincident, in addition to a full coincidence method. Therefore, the method of the present invention can share a secret key of the common key cryptogram between the two nodes on the multi-node network.

In the above embodiment, a case is described in which the asymmetrical waveguide interference system is used as a method of the light communication channel switching. However, in place of the asymmetrical waveguide interference system, devices may be used such as a light micro-electromechanical system (MEMS), a bubble switch, a heat/light switch, and a non-linear optical switch which utilizes micro-machine technology.

The multi-node network of the present invention is not limited to the above embodiments. The asymmetrical waveguide interference system may be not of a 1-input and 2-output type. It is possible to set all the nodes as transmitter nodes by devising the arrangement.

The quantum state cannot be kept when active elements such as a light amplifier are inserted into the communication channel. In the conventional quantum encryptation used photons, therefore, the communication using a private line was permissible only. For example, an optical loss in the optical fiber does not have an influence on the operation principle of the quantum cryptography essentially. This is because photons lost due to the optical loss cannot be detected by a detector and signal distortion due to the optical loss can be excluded surely.

On the other hand, various light communication channel switching techniques are developed in the light network technology in recent years. For example, the light communication channel switching techniques are shown in “Optical Communication Which Breaks Electronics Communication (G. Stix)”, (Nikkei Science, 2001, April, p. 24) which corresponds to “THE TRIUMPH OF THE LIGHT (SCIENTIFIC AMERICAN January 2001), “Optical Switching Technology Which Advance to Practical Use (David. J. Bishop et al.)”, which corresponds to ”THE RISE OF OPTICAL SWITCHING (SCIENTIFIC AMERICAN January 2001), (Nikkei Science, 2001, April, p. 32), and “Last Hurdle-Optical Packet Communication (Daniel J. Blumenthal)”(Nikkei Science, 2001, April, p. 40), which corresponds to “routing packets with light (SCIENTIFIC AMERICAN January 2001)”. The light communication channel switching is realized without using active optical device in most of these papers.

For example, an optical signal multiplexing apparatus and an optical signal demultiplexing apparatus which use an asymmetrical wave guide interference system (AWG) use only the interference effect of light without using any active optical process.

As shown in FIG. 2, if these asymmetrical light waveguide interference systems are used as the optical signal multiplexing apparatus in a transmitter node and the optical signal demultiplexing apparatus in a receiver node, a plurality of quantum communication channels can be multiplexed on a single optical fiber. Moreover, the light communication channel switching can be carried out from the transmitter node to a desired one of the receiver node nodes by selecting the wavelength of the photon by the transmitter node node. In this way, the quantum key can be distributed between optional two of the nodes on the multi-node network.

As described above, according to the present invention, the secret key of the common key cryptogram can be safely shared unconditionally between optional two of the nodes in the multi-node network.

What is claimed is:

1. A quantum cryptography multi-node communication system comprising:
a quantum communication channel; and
a plurality of nodes including a transmission node and a reception node and connected with said quantum communication channel, and
wherein said transmission node transmits a light signal as a time series of photons to said reception node through said quantum communication channel, a quantum state of said photons is modulated, and transmits a quantum state sequence to said reception node, and
said reception node predetermines a quantum state sequence, receives said light signal transmitted from said transmission node, measures quantum states of the received light signal, and determines presence or absence of interception based on said predetermined quantum state sequence, said transmitted quantum state sequence and said measured quantum states.

2. The quantum cryptography multi-node communication system according to claim 1, wherein a single route is predetermined between said transmission node and said reception node.

3. The quantum cryptography multi-node communication system according to claim 2, wherein a reception wavelength of said light signal is assigned to each of said plurality of nodes, and said reception node receives said light signal as the time series of photons with said assigned wavelength.

4. The quantum cryptography multi-node communication system according to claim 1, wherein said plurality of nodes includes a plurality of said reception nodes,
a same wavelength of said light signal is assigned to said plurality of reception nodes, and
each of said plurality of reception nodes receives said light signal with said assigned wavelength, and outputs said light signal with said assigned wavelength onto said quantum communication channel.

5. The quantum cryptography multi-node communication system according to claim 1, wherein each of said plurality of nodes is connected with said quantum communication channel via a passive optical unit, and
said passive optical unit comprises:
a passive wavelength dependent splitter which splits a first light signal component with at least one predetermined first wavelength from said light signal on said quantum communication channel to output to said node; and
a passive wavelength dependent combiner which combines a second light signal component with at least one predetermined second wavelength outputted from said node and said light signal in which said first light signal component is split and outputs the combined light signal onto said quantum communication channel.

6. The quantum cryptography multi-node communication system according to claim 5, wherein said first light signal component is same as said second light signal component.

7. The quantum cryptography multi-node communication system according to claim 5, wherein said first wavelength is same as said second wavelength.

8. The quantum cryptography multi-node communication system according to claim 5, wherein said node outputs said second light signal component with a plurality of said second wavelengths, and
said passive wavelength dependent combiner comprises:
a first splitter which splits said light signal, in which said first light signal component is split, into first signal components with different wavelengths;
a second splitter which splits said second light signal component into second signal components with different wavelengths;
a plurality of first combiners, each of which combines one of said first signal components and a corresponding one of said second signal components to produce a combined signal component; and
a second combiner which combines said combined signal components to output said light signal onto said quantum communication channel.

9. The quantum cryptography multi-node communication system according to claim 1, wherein said transmission node comprises:
a transmission quantum state order storage section which stores a quantum state sequence;
a light signal generating section which generates said light signal as the time series of photons having a predetermined wavelength and modulated based on the quantum states stored in said transmission quantum state order storage section; and
a transmission section which transmits said light signal onto said quantum communication channel, and outputs said quantum state sequence to said reception node.

10. The quantum cryptography multi-node communication system according to claim 1, wherein said reception node comprises:
a first quantum state storage section which stores said predetermined quantum state sequence;
a quantum state measuring section which receives said light signal transmitted from said transmission node through said quantum communication channel, and measures said measured quantum state sequence from said received light signal based on said predetermined quantum state sequence;
a second quantum state storage section which stores said measured quantum state sequence by said quantum state measuring section;
a third quantum state storage section which stores said transmitted quantum state sequence from said transmission node, after the reception of said signal light;
a first comparing section which compares said predetermined quantum state sequence and said transmitted quantum state sequence to detect coincident quantum states;
a fourth quantum state storage section which stores ones of said measured quantum states corresponding to said coincident quantum states as a comparison resultant quantum state sequence;
a second comparing section which compares sampled quantum states which are randomly sampled from said comparison resultant quantum state sequence and ones of said measured quantum state sequence corresponding to said sampled quantum states; and
a determining section which determines the presence or absence of interception based on the comparing result by said second comparing section.

11. A quantum cryptography apparatus to be connected with a quantum communication channel, comprising:
a first quantum state storage section which stores first quantum states of a signal light in a predetermined order;
a quantum state measuring section which receives said signal light which is transmitted through said quantum communication channel, and measures second quantum states of said signal light from said received signal light based on said first quantum states of said signal light stored in said first quantum state storage section;
a second quantum state storage section which stores said second quantum state of said signal light which are measured by said quantum state measuring section;
a third quantum state storage section which stores said first quantum states of said signal light which are transmitted after the reception of said signal light;
a first comparing section which compares said first quantum states stored in said first quantum state storage section and said first quantum states stored in said third quantum state storage section to detect coincident quantum states;
a fourth quantum state storage section which stores ones of said measured second quantum states corresponding to said coincident quantum states;
a second comparing section which compares said second quantum states which are randomly sampled from said second quantum states stored in said fourth quantum state storage section and ones of said measured second quantum states corresponding to said sampled second quantum states; and
a determining section which determines presence or absence of interception based on the comparing result by said second comparing section.

12. The quantum cryptography apparatus according to claim 11, wherein said quantum cryptography apparatus transmits said signal light as a time series of photons to a reception node through said quantum communication channel, a quantum state of said photons is modulated, and transmits said quantum states of said signal light to a reception node.

13. The quantum cryptography apparatus according to claim 12, further comprises:
a transmission quantum state order storage section which stores said quantum states of said signal light;
a light signal generating section which generates said signal light and modulated based on the quantum states stored in said transmission quantum state order storage section; and
a transmission section which transmits said signal light onto said quantum communication channel, and outputs said quantum states of the signal light to said reception node.

14. The quantum cryptography apparatus according to claim 11, wherein a single route is predetermined between said transmission node and said reception node.

15. The quantum cryptography apparatus according to claim 11, wherein a reception wavelength of said signal light is assigned to said quantum cryptography apparatus, and said quantum cryptography apparatus receives said signal light as the time series of photons with said assigned wavelength.

16. A key delivering method in a multi-node network, comprising:
(a) transmitting a light signal as a time series of photons from a transmission node to a reception node through a quantum communication channel, a quantum state of said photons is modulated;
(b) transmitting a quantum state sequence from said transmission node to said reception node;
(c) receiving said light signal transmitted from said transmission node, and measuring a quantum state sequence of the received light signal; and
(d) determining presence or absence of interception based on a quantum state sequence predetermined on said reception node, said transmitted quantum state sequence and said measured quantum state sequence.

17. The method according to claim 16, wherein a single route is predetermined between said transmission node and said reception node.

18. The method according to claim 17, wherein a reception wavelength of said light signal is assigned to each of said plurality of nodes, and
said (c) receiving step includes:
receiving said light signal as the time series of photons with said assigned wavelength.

19. The method according to claim 16, wherein a plurality of nodes are connected with said quantum communication channel and includes a plurality of said reception nodes,
a same wavelength of said light signal is assigned to said plurality of reception nodes, and
said (c) receiving step includes:
each of said plurality of reception nodes receiving said light signal with said assigned wavelength, and outputting said light signal with said assigned wavelength onto said quantum communication channel.

20. The method according to claim 16, wherein said (a) transmitting step comprises:
generating said light signal as the time series of photons having a predetermined wavelength;
modulating said light signal based on a first quantum state sequence; and
transmitting said light signal from said transmission node to said reception node through said quantum communication channel.

21. The method according to claim 16, wherein said (c) receiving step comprises:
receiving said light signal transmitted from said transmission node through said quantum communication channel;
measuring said measured quantum state sequence from said received light signal based on a quantum state sequence predetermined on said reception node;
comparing said predetermined quantum state sequence and said quantum state sequence transmitted from said transmission node to detect coincident quantum states to produce a comparison resultant quantum state sequence indicating coincidence as a comparing result; and
comparing sampled quantum states which are randomly sampled from said comparison resultant quantum state sequence and ones of said measured quantum state sequence corresponding to said sampled quantum states.
